(19) United States
(12) Patent Application Publication
(10) Pub. No.: US 2008/0147633 A1
(43) Pub. Date: Jun. 19, 2008

(54) BRINGING USERS SPECIFIC RELEVANCE TO DATA SEARCHES

(75) Inventor: ADRIAN M. CHANDLEY, SAMMAMISH, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/611,565

(22) Filed: Dec. 15, 2006

(51) Int. Cl. G06F 17/30

(52) U.S. Cl. 707/5; 707/E17.064

(57) ABSTRACT

A search engine provides search results having specific relevance to a user by identifying content that was created and/or used by individuals having a relationship with or sharing characteristics with the user requesting the search. Additionally, the search engine may identify content intended for individuals having characteristics of the user requesting the search. When a user provides a search query to the search engine, user profile information associated with the user is accessed. The search engine identifies content items matching the search query. Additionally, the search engine determines the relevance of the identified content items for the user by comparing the user profile information against context data for the identified content items. The context data for content items include information regarding the individual who created the content items, individual(s) who have used the content items, and/or individuals for whom the content items are intended.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

Although computer systems can store a wealth of information, it can often be difficult for users to find or retrieve specific information. A variety of search engines currently exist that allow users to search for information by entering a search query comprising one or more keywords that may be of interest to the user. After receiving a search request from a user, a search engine identifies a variety of content (e.g., documents, web pages, files, etc.) that are relevant based on the keywords in the search query. Unfortunately, as the amount of available information continues to grow, the search engine often returns search results that include a large number of documents or web pages, many of which have little or nothing to do with the specific information that the user was seeking. As a result, the data a user is looking for is either not found or is buried in a result set that is too large for the user to quickly navigate. The user is then left to sift through the list of documents, links, and associated information to find the desired information. This process can be cumbersome, frustrating, and time consuming for the user.

Search engines have implemented a variety of techniques and algorithms to attempt to refine searches and present the most relevant search results. Typically, such techniques are aimed at providing search results that are relevant to the search query itself, but often fail to provide results that are highly relevant to the user. Some techniques have been developed in an attempt to provide personalized search results. For instance, a user profile associated with a particular user may be used to augment the user's search queries. Additionally, previous searches made by the user may be used to help refine a search. However, these current approaches fall short of adequately providing users with search results that are specifically relevant to the users.

### BRIEF SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments relate to providing search results having specific relevance to a user requesting a search. A search engine may provide relevant search results by identifying content that was created and/or used by individuals having a relationship with or sharing characteristics with the user requesting the search. Additionally, the search engine may identify content intended for individuals having characteristics of the user requesting the search. To facilitate searching and providing relevant search results, context data may be associated with content items. The context data for a content item may include information regarding the individual who created the content item, individual(s) who have used the content item, and/or individuals for whom the content item is intended. When a user provides a search query to the search engine, user profile information associated with the user is accessed. The search engine identifies content items matching the search query. Additionally, the search engine determines the relevance of the identified content items for the user by comparing the user profile information against context data for the identified content items. The search engine then provides search results to the user based on the determined relevance.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a diagram showing a series of concentric circles representing individuals' relationships with a specific user;

FIG. 3 is a block diagram of an exemplary system in which embodiments of the present invention may be employed;

FIG. 4 is a flow diagram showing an exemplary method for providing context data for a content item when the content item is created in accordance with an embodiment of the present invention;

FIG. 5 is a flow diagram showing an exemplary method for indexing context data for a content item in accordance with an embodiment of the present invention;

FIG. 6 is a flow diagram showing an exemplary method for providing context data for a content item when a user uses the content item in accordance with an embodiment of the present invention; and

FIG. 7 is a flow diagram showing an exemplary method for performing a search to provide search results having specific relevance to a user requesting the search in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to providing search results having specific relevance to a user requesting a search. A search engine in accordance with embodiments of the present invention may provide relevant search results by identifying content that was created and/or used by individuals who have a relationship with or share characteristics with the user requesting the search. Additionally, in some embodiments, the search engine may identify content intended for individuals having characteristics of the user requesting the search.

In accordance with embodiments of the present invention, a search engine indexes context data for content items (web pages, documents, files, etc.) in addition to data regarding the content items themselves. Context data indexed for a content item may include information regarding the individual who created the content item, individual(s) who have used the content item, and/or individuals for whom the content item is intended. When a user provides a search query to the search engine, user profile information associated with the user is accessed. The search engine identifies content items matching the search query. Additionally, the search engine determines how relevant the identified content items are to the user by comparing the user profile information against context data for the identified content items. By determining the content items' relevance for the user, the search engine provides search results having specific relevance to the user.

Accordingly, in one aspect of the invention, an embodiment is directed to one or more computer-readable media embodying computer-useable instructions for performing a method for providing a user-relevant data search. The method includes receiving a search query. The method also includes accessing user profile information associated with a user initiating the search query. The method further includes identifying a set of search results based on the search query. The method still further includes determining, for at least one search result, a relevance to the user initiating the search query by comparing at least a portion of the user profile information against context data associated with the at least one search result, wherein the context data comprises information associated with at least one of a user who created content associated with the at least one search result, a user who used content associated with the at least one search result, and a user for whom content associated with the at least one search result is intended.

In another aspect, an embodiment of the invention is directed to one or more computer-readable media embodying computer-useable instructions for performing a method for facilitating a data search. The method includes indexing data for each of a plurality of content items, the data corresponding with content of each of the content items. The method also includes indexing context data for at least a portion of the plurality of content items, the context data for each content item including information associated with at least one of a user who created the content item, a user who used the content item, and a user for whom the content item is intended. The method further includes receiving a search query and accessing user profile information associated with a user initiating the search query. The method also includes identifying at least one content item matching the search query by comparing one or more terms of the search query against the data indexed for the content items. The method still further includes determining, for the at least one content item, a relevance for the user initiating the search query by comparing at least a portion of the user profile information against the context data indexed for the content items.

In a further embodiment of the invention, an aspect is directed to a device having one or more computer-readable media with components embodied thereon for performing a search and providing search results having specific relevance to a user requesting the search. The components includes a searching component configured to perform the search in response to a search query by identifying at least one content item matching the search query. The components also include a relevance component configured to determine, for the at least one content item, a specific relevance to the user requesting the search by comparing user profile information associated with the user requesting the search against context data associated with the at least one content item, the context data including at least one of information associated with a user who created the at least one content item, information associated with a user who used the at least one content item, and information representing an intended user of the at least one content item.

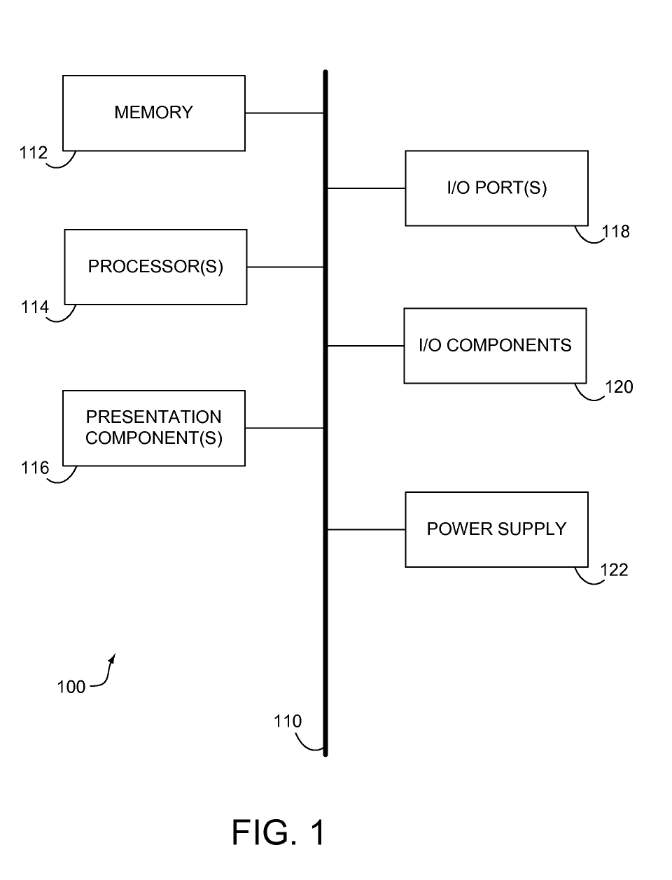

Having briefly described an overview of the present invention, an exemplary operating environment in which various aspects of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

As previously mentioned, embodiments of the present invention relate to providing search results having specific relevance to a user requesting a search. In particular, embodiments recognize that content that is created and/or used by individuals that are similar to or have a relationship with a particular user is more likely to be specifically relevant to that user. In some cases, a user's relationship with another user may indicate that content created or used by each user may be relevant to the other user. For instance, if user A and user Z are part of a community for the same school, if user A and user Z are family members, or if user A is included in user Z's address book, content created or used by user A may be relevant to user Z. Additionally, in some instance, characteristics shared between two users may indicate that content created by each user may be relevant to the other user. For instance, two users who have toddler age children may share similar interests such that content created by one user may be relevant to the other user. Accordingly, in embodiments of the invention, close family members, extended family, neighbors, people in the same communities, people with similar interests, and people with similar characteristics may all have some level of influence in the search results that are returned to a user.

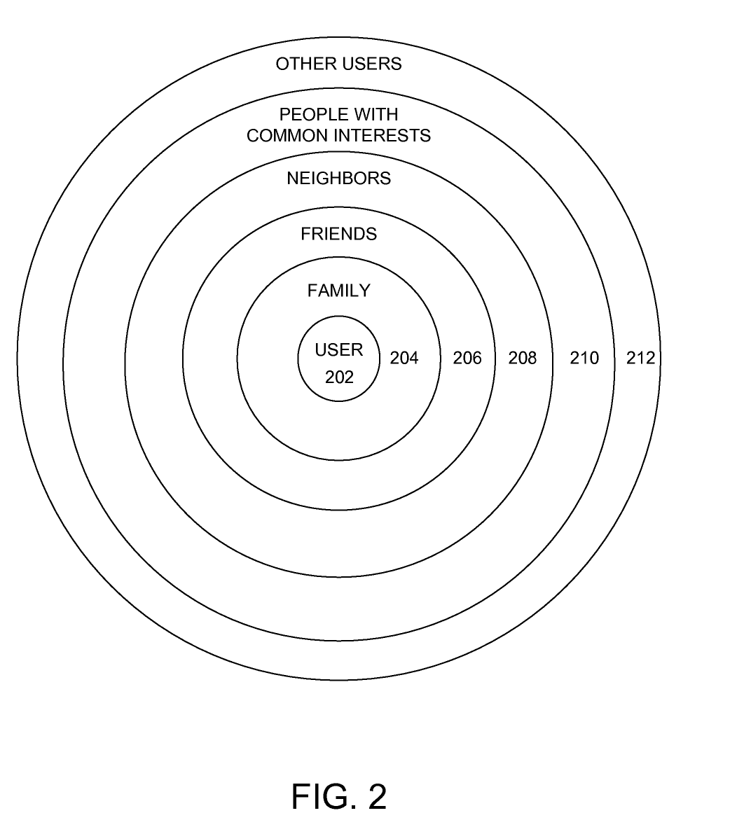

To illustrate users' relationships, FIG. 2 depicts a series of concentric circles representing individuals' relationships to a particular user 202. Individuals in circles closer to the user 202 have a closer relationship to the user. For instance, close family members 204 may have a closer relationship to the user 202 than friends 206, who may have a closer relationship to the user 202 than neighbors 208, who in turn may have a closer relationship to the user 202 than people with common interests 210, who in turn may have a closer relationship to the user 202 than other users 212. Content that is created or used by individuals having a closer relationship to the user (i.e., in a concentric circle closer to the user 202) would likely be more relevant to the user 202. Accordingly, for instance, content created or used by close family members 204 may be more relevant to the user than content created or used by friends 206.

As a specific example of users' characteristics providing an indication of relevance, suppose that user Z is searching for a list of suggested outdoor activities for kids and that users A, B, C, and D have each created a document listing suggested outdoor activities for kids. If user Z performs a search, each of the documents created by users A, B, C, and D may be returned but may have different relevance to the user. For instance, user Z may live in Seattle and have toddlers. However, user A may live in Miami and have teenage children, user B may live in Seattle and have teenage children, user C may live in Denver and have a toddler, and user D may live in Seattle and have toddlers. Because user Z lives in Seattle and is most likely looking for outdoor activities in the Seattle area, lists created by other users living in Seattle are likely to be more relevant to user Z. Additionally, because user Z has toddlers, lists created by other users having toddlers would also likely be more relevant to user Z. Accordingly, the list created by user D would likely have the most relevance to user Z as both users live in Seattle and have toddlers. In contrast, the list created by user D would likely have the least relevance to user Z as user D lives in a different city and has older children.

Accordingly, embodiments of the present invention relate to providing search results having specific relevance to a user requesting a search by associating context data with content items and using the context data during to determine relevance during searches. In some embodiments, context data regarding the creator of a content item may be associated with the content item. Additionally, in some cases, the creator of a content item may specify information regarding an intended user of the content item, and the information may be associated with the content item as context data. Further, as a content item is used by various users, context data regarding the users who have used the content item may be associated with the content item. Context data associated with content items may then be used to facilitate data searches, thereby allowing the identification of search results that have a specific relevance to users requesting the data searches. Relevance may be determined for a data search by comparing user profile information for a user requesting a search against context data associated with content items matching the user's search query.

A search engine in accordance with embodiments of the present invention may provide relevant search results by using context data to identify content items that were created and/or used by individuals who have a relationship with or share similarities with the user requesting the search. Additionally, in some embodiments, the search engine may use context data to identify content intended for individuals having characteristics of the user requesting the search.

Some embodiments of the present invention may be applied in a community environment, in which community software may be employed to hold user profile information for members of the community. In such an environment, content may easily be tagged with context data as it is contributed or used by other users, for instance, by looking for common themes in the user profiles, or similar content they have viewed or contributed. Additionally, relevance for content items may be identified from search terms when members of the community environment perform searches. However, it should be noted that although a community environment may employed, embodiments of the present invention are not limited to such an environment. Instead, embodiments may be employed in different environments and applied to any source of content in any location.

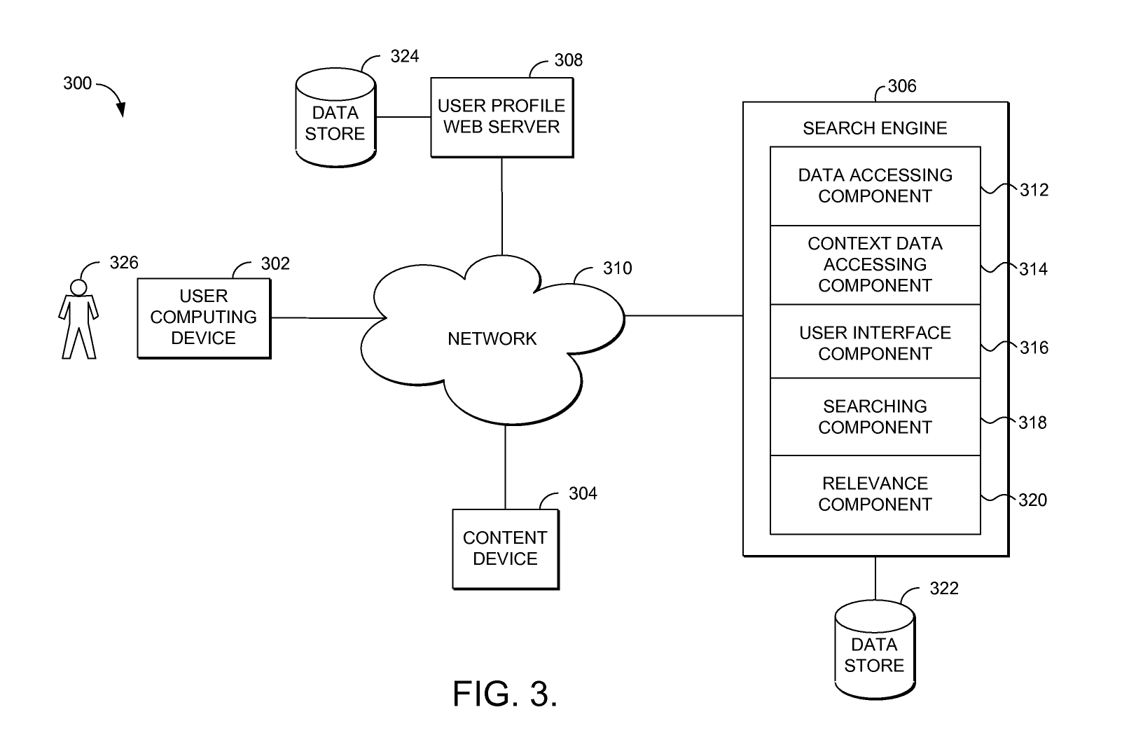

Referring now to FIG. 3, a block diagram is provided illustrating an exemplary system 300 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 300 may include a user computing device 302, a content device 304, a search engine 306, and a user profile web server 308. Each of the user computing device 302, content device 304, search engine 306, and user profile web server 308 may be any type of computing device, such as computing device 100 described with reference to FIG. 1, for example. The components may communicate with each other via a network 310, which may include, without limitation, one or more local area networks (LANs) and/or wide area networks (WANs). Such networking environments are commonplace in offices, enterprise-wide computer networks, intranets, and the Internet. It should be understood that any number of user computing devices, content devices, search engines, user profile web servers, and networks may be employed within the system 300 within the scope of the present invention. Additionally, other components not shown may also be included within the system 300.

Content devices, such as the content device 304, may maintain and provide users access to a variety of content items. Any type of content may be maintained by content devices, such as the content device 304. By way of example only and not limitation, the content device 304 may be a web server storing a webpage or other document. In embodiments in which a community environment is employed, content items maintained by the content device 304 may include, for instance, lists and calendar events that are intended to be shared within the community environment.

Generally, the search engine 306 may facilitate searches in accordance with embodiments of the present invention to provide search results having specific relevance to users requesting searches. The search engine 306 may index both data regarding content items themselves, such as content items on the content device 304, as well context data regarding the creator of content items, user(s) of content items, and intended user(s) of content items. Accordingly, the search engine 306 may receive a search query from the user 326 via the user computing device 302, and provide search results that are specifically relevant to the user 326.

Among other components not shown, the search engine 306 may include a data accessing component 312, a context data accessing component 314, a user interface component 316, a searching component 318, and a relevance component 320. Each component may comprise a program, a routine, application, or other machine-executable code capable of performing actions substantially described herein. One skilled in the art will recognize that the components of the search engine 306 shown in FIG. 3 are provided for illustrative purposes only and other arrangements may be provided in accordance with various embodiments of the present invention.

The data accessing component 312 of the search engine 306 may access data corresponding with content stored on content devices, such as the content device 304. The data may be indexed in a data store 322 associated with the search engine 306 to facilitate searches. Data indexed for content may include, for instance, terms extracted from the content (e.g., titles, headings, text, etc.) and/or tags associated with the content. The data corresponds directly with the content itself. In some cases, the data accessing component 312 may access the data by crawling content devices. In other cases, content devices may feed data to the data accessing component 312.

The search engine 306 also includes a context data accessing component 314 for accessing context data corresponding with content items. The context data is also indexed in the data store 322 to further facilitate searching in accordance with embodiments of the present invention. As indicated previously, as opposed to data regarding the content itself, the context data includes information regarding the creator of content items, user(s) of content items, and/or users for whom content items are intended.

In some embodiments, context data for content may be maintained by the content device 304 in conjunction with the content. Accordingly, when the search engine 306 crawls the content device 304 and/or receives a data feed from the content device 304, the search engine 306 may access data regarding the content as well as the context data and may index the data.

In additional embodiments, the search engine 306 may access context data from the user profile web server 308, which may be associated with a data store 324 that stores user profiles. For instance, in some cases, when the search engine 306 accesses data regarding content maintained by the content device 304, the search engine 306 may communicate with the profile web server 308 to access a user profile associated with the creator of the content and index context data from the user profile. In other cases, when content is used by a user, the search engine 306 may communicate with the profile web server 308 to access a user profile associated with that user and index context data from the user profile. Users may access the user profile web server 308 to create and edit their user profiles manually and/or the user profile web server 308 may automatically generate user profile information (e.g., by tracking user activities). By way of example only and not limitation, information included in a user profile may include a user ID, age, gender, residence location, marital status, family information, community information, address book information, personal preferences, and interests (e.g., “I like rock music,” “my favorite color is blue,” “I like going to the movies,” “I am a photographer,” etc.).

In further embodiments, user profile information may be maintained on a user's computing device, such as the user computing device 302, and other devices throughout the system 300. In such cases, context data may be accessed from these other devices and indexed by the search engine 306.

The search engine 306 may receive search queries from user computing devices, such as the user computing device 302, via the user interface component 316. A search query may be initiated, for instance, by a user, such as the user 326 associated with the user computing device 302. The user interface component 316 may communicate to receive search queries from user computing devices and pass the search queries to the searching component 318 for performing searches. The user interface component 316 also communicates search results to the user computing devices requesting searches.

The searching component 318 may receive a search query from the user interface component 316 and perform a search to generate search results. In particular, the searching component 318 may use one or more keywords provided in a search query to identify content items having indexed data matching the search query.

The relevance component 320 may determine search results having relevance to the user requesting the search. In particular, when the search engine 306 receives a search query, the search engine 306 also accesses user profile information for the user requesting the search. The search engine 306 may access user profile information in a number of different manners within the scope of embodiments of the present invention. In one embodiment, the search query includes the user profile information. For instance, the user computing device 302 may maintain user profile information for the user 326 such that when a search query is communicated from the user computing device 302 to the search engine 306, the user profile information may be communicated in conjunction with the search query. In another embodiment, the search engine 306 may request user profile information after receiving a search query. For instance, a search query from the user computing device 302 may include an identifier of the user 326 requesting the search. Using the identifier, the search engine 306 may request and receive user profile information from the user profile web server 308. In a further embodiment, the search engine 306 may store user profile information locally, for example, in the data store 322. Any and all such variations are contemplated within the scope of embodiments of the present invention.

Using the user profile information for the user 326 requesting the search, the relevance component 320 may determine search results' relevance to the user 326. In particular, the relevance component 320 may compare the user profile information against context data indexed in the data store 322 to determine content items that have a specific relevance to the user 326. In some embodiments, this may include comparing characteristics of the user 326 against characteristics included in the indexed context data. As indicated previously, the characteristics included in the context data for a content item may include characteristics of the user who created the content item, characteristics of user(s) who have used the content item, and characteristics of an intended user of the content item. In other embodiment, determining content items that have a specific relevance to the user 326 may include identifying content created and/or used by users having a relationship with the user 326.

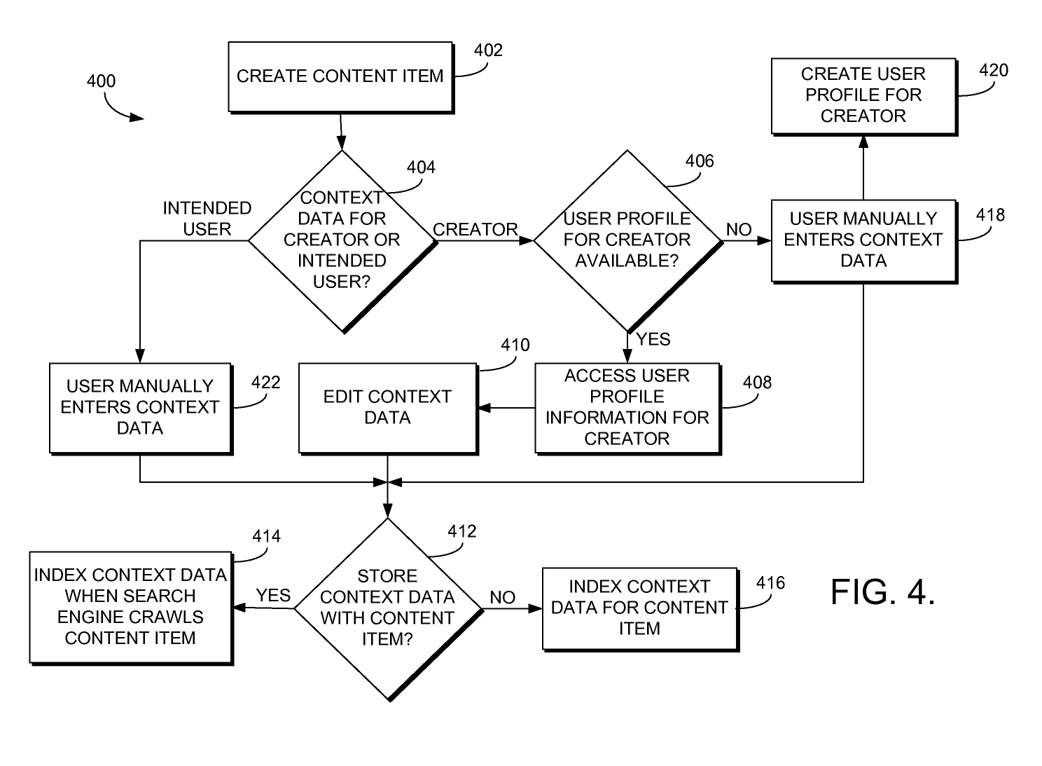

Turning now to FIG. 4, a flow diagram is provided illustrating an exemplary method 400 for providing context data for a content item when the content item is created in accordance with an embodiment of the present invention. In particular, the context data includes information regarding the user creating the content item and/or information regarding users for whom the content item is intended. Initially, as shown at block 402, a content item is created by a user, who is herein referred to as the creator of the content item. At block 404, a determination is made whether context data associated with the creator and/or an intended user of the content item will be provided for the content item. Either or both types of context data may be provided for a content item in various embodiments of the present invention.

If context data is to be provided for the creator of the content item, whether a user profile for the creator is available is determined at block 406. A user profile may be stored, for instance, at a user profile web server, such as the user profile web server 308 of FIG. 3. Alternatively, a user profile for the creator may be stored at another location. If a user profile for the creator is available, information from the user profile is accessed, as shown at block 408. In some embodiments, the entire user profile is accessed. In other embodiments, only a portion of the user profile is accessed. For instance, only certain items of information within the user profile may be relevant to the type of content item being created. In such instances, only those relevant information items may be accessed.

In some embodiments, the information accessed from the user profile may be modified by the creator, as shown at block 410. For instance, the creator may wish to add, delete, or change information from the user profile that will be used as context data for the content item. Accordingly, the creator may exert some control over the context data that will be provided for the content item.

As represented at block 412, the context data derived from the user profile information may or may not be stored with the content item itself. If the context data is stored with the content item, in some cases, the context data may be indexed by a search engine when the search engine crawls the content item and captures data regarding the content item, as shown at block 414. If the context data is not stored with the content item, the context data may be provided to a search engine or another component, which may index the context data for the content item, as shown at block 416.

If, at block 406, it was determined that a user profile was not available for the creator, the creator may manually enter context data for the content item, as shown at block 418. For instance, a user interface may be provided to the creator that allows the creator to enter context data for the content item. The context data provided by the creator is then stored with the content item and/or indexed elsewhere (e.g., at a search engine), as represented at blocks 412, 414, and 416. Additionally, in some cases, the information entered by the creator may be used to create a user profile for the creator, as shown at block 420.

Referring again to block 404, if context data regarding an intended user is to be provided, the creator may manually enter context data for the content item, as shown at block 422. For instance, a user interface may be provided to the creator that allows the creator to enter context information for the content item. In particular, the creator may provide characteristics of users for whom the content item is intended. The context data provided by the creator is then stored with the content item and/or indexed elsewhere (e.g., at a search engine), as represented at block 412, 414, and 416.

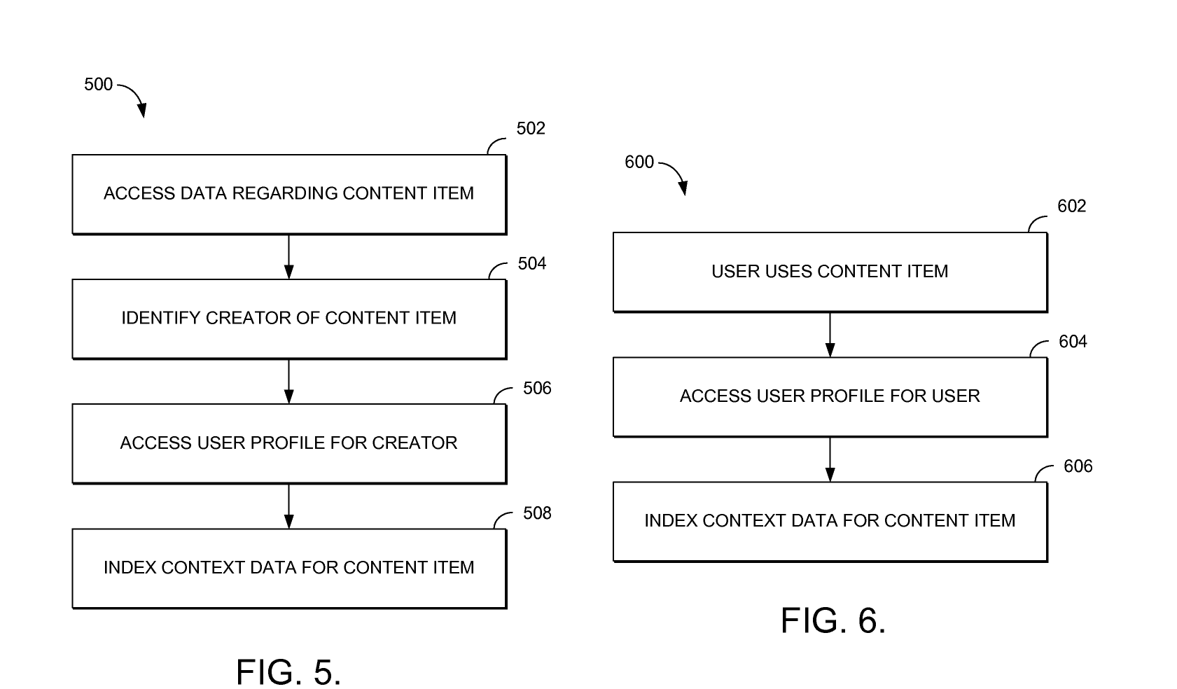

In some cases, context data regarding the creator of a content item may not be associated with the content item when it is created, but, instead, may be associated with the content item and indexed by a search engine when the search engine crawls the content item. For instance, referring to FIG. 5, a flow diagram is provided showing an exemplary method 500 for a search engine to access user profile information for a creator of a content item when the search engine indexes data regarding the content item. Initially, as shown at block 502, the search engine accesses data regarding the content item. In some cases, the search engine may crawl the content item to access the data. In other cases, the search engine may be fed the data. Additionally, as shown at block 504, the search engine identifies the creator of the content item. Based on this identification, the search engine accesses a user profile for the creator, as shown at block 506. Typically, the search engine accesses the user profile from a user profile web server, such as the user profile web server 308 of FIG. 3, although the user profile may be stored locally by the search engine or stored at another location. After accessing the user profile, the search engine indexes context data for the content item, as shown at block 508. In some embodiments, the search engine may index all information within the user profile. In other embodiments, the search engine may index only a potion of the information within the user profile (e.g., only certain items of information may be relevant for the content item). In further embodiments, the search engine may merely index a pointer to the user profile. In such embodiments, the user profile may be accessed as necessary using the pointer when a search is performed.

Referring now to FIG. 6, a flow diagram is provided showing an exemplary method 600 for providing context data for a content item when a user uses the content item in accordance with an embodiment of the present invention. Initially, as shown at block 602, a user uses a content item. Use of a content item may comprises a number of different activities by a user within the scope of embodiments of the present invention. By way of example only and not limitation, use of a content item may include directly importing the content item into an application. For instance, if the content item were a list or an appointment item, use of the content item may include importing the item into the user's calendar. As another example, use of a content item may include the user rating or reviewing the content item. In some cases, a user merely accessing and viewing a content item (e.g., visiting a web page) may be considered a use. Preferably, however, the activity provides some indication regarding whether the user regarded the content item as being relevant.

In some embodiments, use of a content item may occur in conjunction with a search. For instance, search results may be provided to a user and the user may rate some of the results. As another example, when a user selects a search result to access the associated content item, the user may rate the content item. In some cases, the user selecting a search result may be sufficient. Although use of a content item by a user may be in conjunction with a search, it should be understood that in embodiments, a user may access/use a content item independent of a search.

As shown at block 604, when the user uses the content item, user profile information for the user is accessed. In some embodiments, user profile information may be accessed from a user profile web server, such as the user profile web server 308 in FIG. 3. In other embodiments, user profile information may be accessed for another location, such as, for instance, stored locally on a user computing device associated with the user.

Based on the user profile information, context data is indexed for the content item, as shown at block 606. For instance, a search engine may index the context data, which may include all or a portion of the user profile information. In some embodiments, the context data indexed for the content item may include information regarding the use of the content item by the user. For example, if a user rates or reviews the content item, information regarding the rating or review may be included with the context information. Such information may further assist identifying whether the content item will be relevant for other users.

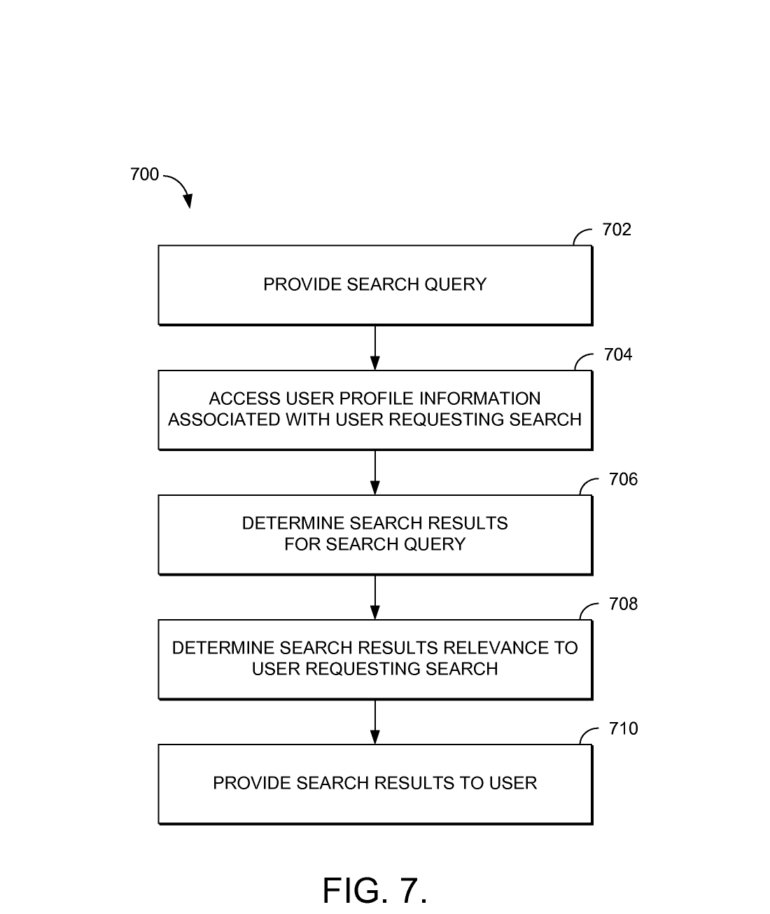

Turning now to FIG. 7, a flow diagram is provided showing an exemplary method 700 for performing a data search to provide search results having specific relevance to a user requesting the search in accordance with an embodiment of the present invention. Initially, as shown at block 702, a search query, which may include one or more keywords, is provided by a user. At block 704, user profile information associated with the user is accessed. As mentioned previously, in some embodiments, user profile information may be stored locally on a user computing device associated with the user. Additionally, user profile information may be stored by a user profile web server, such as the user profile web server 308 of FIG. 3. Further, user profile information for the user may be distributed among numerous network components. In various embodiments of the present invention, user profile information may be accessed from any of these locations.

As shown at block 706, search results are determined for the search query. In particular, the search results are determined by comparing keywords in the search query with indexed data. Each search result's relevance to the user requesting the search is determined at block 708. Relevance for a search result may be determined by comparing user profile information for the user requesting the search against context data indexed for a content item corresponding with the search result. In some embodiments, relevance may be determined by comparing characteristics of the user requesting the search against characteristics, within the context data, of the user who created the content item, characteristics of user(s) who have used the content item, and/or characteristics of users for whom the content item was intended. In some embodiments, relevance may be determined by identifying one or more users within the context data who have a relationship with the user requesting the search.

Search results are communicated to the user requesting the search, as shown at block 710. In some embodiments, the search results are ranked based on each result's relevance to the user. Additionally, in some embodiments, only search results determined to have some relevance to the user are provided; while in other embodiments, all search results are provided to the user.

As can be understood, embodiments of the present invention relate to data searches that provide search results having specific relevance to the user requesting the search. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer-readable media embodying computer-useable instructions for performing a method for providing a user-relevant data search, the method comprising:
receiving a search query;
accessing user profile information associated with a user initiating the search query;
identifying a set of search results based on the search query; and
determining, for at least one search result, a relevance to the user initiating the search query by comparing at least a portion of the user profile information against context data associated with the at least one search result, wherein the context data comprises information associated with at least one of a user who created content associated with the at least one search result, a user who used content associated with the at least one search result, and a user for whom content associated with the at least one search result is intended.

2. The one or more computer-readable media of claim 1, wherein accessing user profile information associated with the user initiating the search query comprises accessing at least a portion of the user profile information from a computing device initiating the search query.

3. The one or more computer-readable media of claim 1, wherein accessing user profile information associated with the user initiating the search query comprises accessing at least a portion of the user profile information from a user profile web server.

4. The one or more computer-readable media of claim 1, wherein the user profile information associated with the user initiating the search query comprises at least one of a user ID, age, gender, residence location, marital status, family information, community information, address book information, personal preference, and interest.

5. The one or more computer-readable media of claim 1, wherein the context data associated with the at least one search result includes information associated with at least one of a user who created content associated with the at least one search result, a user who used content associated with the at least one search result, and a user for whom content associated with the at least one search result is intended, the information comprising at least one of a user ID, age, gender, residence location, marital status, family information, community information, address book information, personal preference, and interest.

6. The one or more computer-readable media of claim 1, wherein determining, for at least one search result, a relevance to the user initiating the search query comprises identifying at least one characteristic of the user initiating the search query within the user profile information matching at least one characteristic within the context data associated with the at least one search result.

7. The one or more computer-readable media of claim 1, wherein determining, for at least one search result, a relevance to the user initiating the search query comprises identifying, within the context data associated with the at least one search result, at least one user having an association with the user initiating the search query.

8. The one or more computer-readable media of claim 7, wherein the at least one user having an association with the user initiating the search query comprises at least one of a user included in an address book of the user initiating the search query, and a user within a community common with the user initiating the search query.

9. The one or more computer-readable media of claim 1, wherein the method further comprises communicating at least a subset of the search results to the user initiating the search query.

10. The one or more computer-readable media of claim 9, wherein communicating at least a subset of the search results to the user initiating the search query comprises ranking at least the subset of the search results based at least in part on the relevance for at least one search result.

11. One or more computer-readable media embodying computer-useable instructions for performing a method for facilitating a data search, the method comprising:
indexing data for each of a plurality of content items, the data corresponding with content of each of the content items;
indexing context data for at least a portion of the plurality of content items, the context data for each content item including information associated with at least one of a user who created the content item, a user who used the content item, and a user for whom the content item is intended;
receiving a search query;
accessing user profile information associated with a user initiating the search query;
identifying at least one content item matching the search query by comparing one or more terms of the search query against the data indexed for the content items; and
determining, for the at least one content item, a relevance for the user initiating the search query by comparing at least a portion of the user profile information against the context data indexed for the content items.

12. The one or more computer-readable media of claim 11, wherein indexing context data for at least a portion of the plurality of content items comprises:
accessing, for a content item, a user profile associated with a user who created the content item; and
indexing context data based on information within the user profile associated with the user who created the content item.

13. The one or more computer-readable media of claim 11, wherein indexing context data for at least a portion of the plurality of content items, comprises:
accessing, for a content item, a user profile associated with a user who used the content item; and
indexing context data based on information within the user profile associated with the user who used the content item.

14. The one or more computer-readable media of claim 11, further comprising communicating search results to the user initiating the search query, the search results including the at least one content item matching the search query.

15. The one or more computer-readable media of claim 14, further comprising ranking at least a subset of the search results based at least in part on the relevance identified for the at least one content item.

16. A device having one or more computer-readable media with components embodied thereon for performing a search and providing search results having specific relevance to a user requesting the search, the components comprising:
a searching component configured to perform the search in response to a search query by identifying at least one content item matching the search query; and
a relevance component configured to determine, for the at least one content item, a specific relevance to the user requesting the search by comparing user profile information associated with the user requesting the search against context data associated with the at least one content item, the context data including at least one of information associated with a user who created the at least one content item, information associated with a user who used the at least one content item, and information representing an intended user of the at least one content item.

17. The device of claim 16, further comprising a data store storing data regarding a plurality of content items and context data associated with at least one of the plurality of content items, the context data including at least one of information associated with a user who created the at least one content item, information associated with a user who used the at least one content item, and information representing an intended user of the at least one content item.

18. The device of claim 16, further comprising a user interface component configured to receive the search query and to communicate search results to the user requesting the search.

19. The device of claim 16, further comprising a data accessing component configured to access data corresponding with content of a plurality of content items and to index the data.

20. The device of claim 16, further comprising a context data accessing component configured to access context data associated with a plurality of content items, the context data for each of the plurality of content items including at least one of information associated with a user who created the content item, information associated with a user who used the content item, and information representing an intended user of the content item.
